(19) United States
(12) Patent Application Publication
(10) Pub. No.: US 2006/0229393 A1
(43) Pub. Date: Oct. 12, 2006

(54) Compositions and methods for enhancing brightness and brightness stabilization in papermaking

(76) Inventors: Prasad Duggirala, Naperville, IL (US); Sergey Shevchenko, Aurora, IL (US)

Correspondence Address: NALCO COMPANY, 1601 W. DIEHL ROAD, NAPERVILLE, IL, 60563-1198, US

(21) Appl. No.: 11/102,318

(22) Filed: Apr. 8, 2005

(51) Int. Cl. D21H 21/30; C08K 5/00; C08K 5/41; C08K 3/30

(52) U.S. Cl. 524/167; 162/162; 162/184; 106/499; 106/503; 106/505; 524/418

(57) ABSTRACT

A Penetrant compound that preserves and enhances the brightness of a ligno-cellulosic material comprising (i) a reductive nucleophilic agent and (ii) a chelant in a paper or tissue machine. This Penetrant compound preserves and enhances the brightness of a ligno-cellulosic material when applied during different stages of the papermaking process. Penetrant compound maintains and/or enhances brightness, prevent yellowing, and enhances the performance of optical brighteners of pulp or a paper sheet produced by methods wherein the penetrant compound is applied in the papermaking process.

### FIELD OF THE INVENTION

This invention relates to the field of ligno-cellulosic material production, in particular, to brightness enhancement and stabilization against thermal yellowing of ligno-cellulosic materials such as paper and bleached pulp.

### BACKGROUND OF THE INVENTION

Ligno-cellulosic materials such as wood are the raw materials used for the production of pulps and papers. In order to make paper, ligno-cellulosic materials are first reduced to pulps of discrete fibers by a pulping process. The three major types of pulping processes are chemical, mechanical and chemi-mechanical.

Pulping yields materials that typically range in color from a pale-yellow to deep brown. Bleaching of these pulps to a whiter color is needed prior to the process of papermaking. Photo-yellowing and thermal aging are processes which negatively impact the commercial value of paper mills. Photo-yellowing occurs primarily in finished paper while thermal aging occurs in both pulp and finished paper. To date, research efforts have concentrated on the problem of photo-yellowing which is important for the long-term use but not relevant to papermaking per se. There have been a number of different approaches proposed to prevent the photo-induced discoloration yellowing of mechanical pulps. One approaches for prevention of photo-yellowing is exemplified in U.S. Pat. No. 6,599,326 entitled “Inhibition of pulp and paper using hydroxylamines and other coadditives”. Here stabilizing amounts of a N,N-dialkylhydroxylamine, an ester, amide or thio substituted N,N-dialkylhydroxylamine or N,N-dibenzylhydroxylamine or an amminium salt thereof prevent brightness loss in high-yield wood pulps which undergo rapid light-induced discoloration, particularly near ultraviolet light (wavelengths 300-440 nm) in indoor fluorescent light and daylight.

In contrast to light-induced discoloration discussed above, the effects of thermal aging remain unresolved. Mechanistically, thermal aging is less understood than photo-yellowing. It is believed that thermal aging results in two separate problems. First, there is a slow brightness loss in finished paper. Second, there is a fast brightness loss in pulp itself that occurs at a pulp and paper mill during the storage and processing, and also during formation of paper (especially in the dryer). U.S. Pat. No. 6,527,914 entitled “Method of enhancing brightness and brightness stability of paper made from mechanical pulp” provides a component mixture comprising polyamino polyether methylene phosphonate (PAPEMP) and .alpha.-glucoheptonic-.gamma.-lactone (GL) to enhance the initial brightness and brightness stability of paper made with Mechanical Pulp. This patent, however, does not address a paper machine process and does not present a complete approach to thermal aging in the papermaking process. Therefore, a successful and practical approach to prevent thermal-induced yellowing of bleached pulps accompanied with loss of brightness gained from bleaching when exposed to heat during storage or in the process of papermaking remains a significant challenge to the industry.

A need for brightness stabilization and enhancement at various stages in the papermaking process exists in the industry. A successful approach to this problem would be cost-efficient, capable of being tailored to the needs of individual mills, and conveniently added to the mill's current operation.

### SUMMARY OF THE INVENTION

The present invention provides compositions for enhanced brightness and brightness stabilization in the papermaking process through application of a penetrant compound comprising (i) a reductive nucleophilic agent and (ii) a chelant applied to ligno-cellulosic material. Typical Penetrant compounds include (i) water-soluble inorganic sulfites, bisulfites, metabisulfites, substituted phosphines and tertiary salts thereof, formamidinesulfinic acid and salts thereof, or formaldehyde bisulfite adduct and (ii) organic phosphonates, phosphates and/or carboxylates and salts thereof. Application of the penetrant compound results in pulp and/or paper having higher brightness and enhanced resistance to thermal yellowing, prevents thermal brightness loss in a paper or tissue machine and improves the performance of optical brighteners at discrete steps in the papermaking process.

Methods incorporating representative penetrant compounds, result in increased optical properties of paper by impacting discrete steps in the papermaking process.

### DETAILED DESCRIPTION OF THE INVENTION

Description of Terms.

As used throughout this application, the following terms are described as:

“Brightness” is a measurement of the ability of a sample to reflect monochromatic (457 nm) light as compared to a known standard, using magnesium oxide (MgO). Brightness is a term used to describe the whiteness of pulp or paper, on a scale from 0% (absolute black) to 100% (relative to a MgO standard, which has an absolute brightness of about 96%) by the reflectance of blue light (457 nm) from the paper.

“Ligno-cellulosic material” is a material of natural origin consisting of cellulose and lignin as major components; the examples are wood, non-wooden plant materials, cotton, original and recycled paper products, including but not limited to, pulp, paper and paperboard.

“Penetrant compound” is a water-soluble chemical comprising (i) a reductive nucleophilic agent and (ii) a chelant, which can be applied on paper or pulp in a solution in a manner ensuring relatively homogeneous distribution of the compound on sample surface or on fibers.

“A reductive nucleophilic agent” is a nucleophilic chemical capable of being also a substrate of oxidative reactions.

“Chelant” means a chemical that forms stable coordination complexes with metal ions.

“Paper Machine” is the primary machine in a paper mill on which slurries containing fibers and other constituents are formed into a sheet by the drainage of water, pressing, drying, winding into rolls, and sometimes coating.

“Tissue Machine” is the primary machine to manufacture thin, low weight, gauze-like type of paper made from virgin and/or reclaimed pulp, used to manufacture such items as sanitary products, wrapping material, protective packing paper, stock for waxing and twisting, etc.

“Organic phosphonate” is a class of chemicals containing an organic group directly connected to the phosphorous functional group via a carbon atom, of a general formula R—P(═O)(OH)2, in particular, chelants such as aminomethylene phosphonates of a formula RR′NCH2 P(═O)(OH)2, such as DTMPA, of a formula [(OH)2(0=)]2PCH2—NCH2CH2N[CH2 P(═O)(OH)2]CH2CH2N[CH2P(═O)(OH)2]2

“Organic phosphate” is a class of chemicals containing an organic group connected to the phosphorous functional group via an oxygen atom, of a general formula R—O—P(═O)(OH)2, in particular, chelants such as aminoethylene phosphonates of a formula RR′NCH2CH2—O—P(═O)(OH)2, such as triethanolamine triphosphate ester, of a formula N[CH2CH2OP(═O)(OH)2]3.

“Carboxylate” is a class of organic acids, of a general formula R—COOH, where R is an organic group, in particular, chelants such as aminomethylenecarboxylates of a formula RR′NCH2COOH, such as DTPA, of a formula (HOOCCH2)2NCH2CH2N(CH2COOH)CH2CH2N(CH2COOH)2

“Wet sheet” is a paper sheet with a moisture content higher than 15%.

“Dry sheet in a size press” is a paper sheet with a moisture content lower than 15% that passes, during the papermaking process, through a paper mill processing unit consisting of two, ususlly rubber-covered, rolls located between two dry end sections of the paper machine (used to apply size solution to the surface of the paper sheet)

“Split-fed” is a way of application of the penetrant compound which involved applying part of the dose on a wet sheet (before the dryers) and part in a size press of the paper machine

“Thermal brightness loss” is a brightness loss in paper and pulp under the influence of time, temperature and moisture (non-photochemical brightness loss).

“Yellowing of a ligno-cellulosic material (brightness reversion) is the loss of brightness of bleached pulp, paper, paperboard and related materials over a period of time (brightness is a measure of the degree of reflectivity of a sheet of paper or pulp for blue light measured under specified standard conditions)

“Whitening agents” or “optical brighteners” are fluorescent dyes or pigments that absorb ultraviolet radiation and reemit it at a higher frequency in the visible spectrum (blue), thereby effecting a white, bright appearance to the paper sheet when added to the stock furnish.

“Brightness loss during storage” is thermal brightness loss over time under storage conditions.

“Papermaking” as used herein, includes the making of paper from bleached pulp through discrete process steps resulting in paper formation.

“Sizing agents” include, but are not limited to cationic or anionic surface sizing polymers.

Novel compositions that preserve and enhance brightness of chemical and mechanical pulps and combinations thereof in the paper machine are identified. These compositions also enhance the effect of optical brighteners (OBA). Brightness recovery in papermaking represents a significant breakthrough. The compositions instantly claimed provide economic feasibility and individualized treatment to the mills. The instantly claimed compositions deliver a brighter and more optically stable paper thus allowing the mill to reduce bleaching chemicals and expensive optical brighteners, or to produce value-added products.

The loss of brightness in the paper drying process present an ongoing challenge to the industry. The tendency of paper to turn yellow when exposed to heat and humidity is thought to be caused by the response of carbonyl groups to the effects of heat and temperature.

To attack this problem, Applicants' provide Penetrant compound comprising a chelant, such as phosphonate with a selected reducing/nucleophilic chemical such as bisulfite. This mixtures provides synergy when applied to the wet or dry sheet strongly increasing brightness of the sheet. Dithiocarbamates and derivatives such as 3,5-dimethylperhydrothiadiazine-2-thion, applied in a very small quantity, add to the brightness and increased stability of the paper towards thermal aging. The synergistic effect of the penetrant compound effect fully compensates for the brightness loss in the drying drums of the paper machine. Moreover, brightness gain i.e. brightness higher than in an air-dry sheet is often achieved.

The penetrant compound can be applied to wet pulp to stabilize it in the paper machine or tissue machine or to dry pulp in a size press to compensate for brightness loss and to enhance performance of optical brighteners (fluorescent whitening agents). It also can be applied to wet pulp to prevent brightness loss during storage.

The instant claimed invention is the discovery that there is a synergism between a chelant such as DTMPA and a nucleophilic agent such as bisulfite that impact brightness of paper at discrete steps of the papermaking process.

Applicants' further discovered that the addition of polyacrylic acid as part of DTMPA functioned as well as DTMPA alone. This is valuable discovery because polyacrylic acid is much less expensive than DTMPA.

DTMPA is known in the art and can be obtained through known chemical supply companies. The preferred salt of DTMPA for use in the Penetrant compound of the instant claimed invention is the sodium salt when a sodium base, such as sodium hydroxide, is used and it is the potassium salt when a potassium base, such as potassium hydroxide, is used.

Polyacrylic acid is a known chemical and can be obtained through known chemical supply houses. The preferred salt of polyacrylic acid is sodium polyacrylate when a sodium base, such as sodium hydroxide, is used and it is potassium polyacrylate when a potassium base, such as potassium hydroxide, is used.

The Penetrant compound comprises a mixture of at least one of:
(a) DTMPA (diethylenetriaminepentakis(methylphosphonic acid), sodium salt)—0.01-2%, preferred 0.05-0.2%
(b) Triethanolamine triphosphate ester, sodium salt—0.01-2%, preferred 0.05-0.2%
(c) DTPA (diethylenetriaminepentaacetic acid, sodium salt)—0.01-2%, preferred 0.05-0.2%
(d) EDTA (ethylenediaminetetraacetic acid, sodium salt)—0.01-2%, preferred 0.05-0.2%
(e) Sodium polyacrylate (PA)—0.005-1%, preferred 0.02-0.1%
(f) Sodium bisulfite (commercial mixture of sodium bisulfite and sodium metabisulfite, 59-67% SO2)—0.01-2%, preferred 0.05-0.2%
(g) Tris(hydroxymethyl)phosphine, tris(carboxyethyl)phosphine, or bis-tetrakis(hydroxymethyl)phosphonium sulfate (THPS)—0.01-2%, preferred 0.05-0.2%
(h) Formamidinesulfinic acid (FAS)—0.01-2%, preferred 0.05-0.2%
(i) Formaldehyde sodium bisulfite adduct—0.01-2%, preferred 0.05-0.2%
(j) 3,5-Dimethylperhydrothiadiazine-2-thion (Thione) or (or DTC)—0.0001-0.01%, preferred 0.001-0.003%

It has been found that when this Penetrant compound is added to paper or bleached pulp that it works to either maintain or ever enhance their across the paper or tissue machine. Or the Penetrant compound can be used to maintain the brightness of the paper made of bleached pulp while amount(s) of other chemicals typically added in course of the papermaking process are reduced.

The Penetrant compound also works to either enhance or maintain the brightness of recycled pulp and paper made of recycled pulp, wherein the recycled pulp comprises chemical pulp or mechanical pulp or a blend of chemical and mechanical pulp. The pH range of the penetrant compound is from 3-8. Optimal activity occurs at a pH of about 5 to about 6.

Optimal synergism includes a chelant and reducing/nucleophilic component. The thione (sulfur-organic component) can be applied together with other components or separately at the size press, better in combination with one of the other components. In the apper machine or tissue machine, the wet end application provides sustainable brightness gain, the split-feed application provides more long-term brightness stability. The composition also can be applied to the dry sheet in a size press. For pulp stabilization, the chemicals can be added directly to the pulp slurry.

Representative Penetrant compounds include, but are not limited to: (water not included).

| Trace # | Component | % Component |
|---|---|---|
| Composition A | DTMPA | 6.9 |
| | Sodium | 3.4 |
| | polyacrylate | |
| | NaOH | 1.5 |
| | Sodium | 27 |
| | Metabisulfite | |
| Composition B | DTMPA | 9.0 |
| | NaOH | 3.6 |
| | Sodium | 27 |
| | Metabisulfite | |
| Composition C | DTMPA | 6.0 |
| | NaOH | 3.0 |
| | Sodium | 30 |
| | Metabisulfite | |
| Composition D | DTMPA | 5.0 |
| | DTPA | 4.1 |
| | NaOH | 1.5 |
| | Sodium | 30 |
| | Metabisulfite | |
| Composition E | DTMPA | 7.4 |
| | NaOH | 5.5 |
| | Sodium | 16.7 |
| | Metabisulfite | |
| | FAS | 7.7 |
| Composition F | DTMPA | 4.2 |
| | NaOH | 2.8 |
| | Sodium | 19.9 |
| | Metabisulfite | |
| | THPS | 9.8 |
| | DTPA | 4.1 |
| | NaNO2 | 0.1 |

The Penetrant compound, having a pH between 5 to 6 can be applied directly to the wet sheet before the dryers, to the dry sheet in a size press or split-fed. In some tests, a pre-formulated DTMPA/polyacrylate (PA) composition (Composition G), 2:1 DTMPA:PA ratio, 33% actives, pH 5.7 was used.

This Penetrant compound also works to either enhance or maintain the brightness of paper made of recycled pulp, wherein the recycled pulp comprises chemical pulp or mechanical pulp or a blend of chemical and mechanical pulp.

Brightness stabilization against thermal yellowing and brightness enhancement of lignocellulosic materials can be achieved by treatment of a water-soluble penetrant compound comprising a water-soluble phosphonate and a bisulfite. As an alternative benefit of having added the instant claimed Penetrant compound to mechanical pulp, it is known that the amount of other brightness-enhancing chemicals such as optical brighteners (OBA) can be reduced. Replacing some of the OBA with the Penetrant compound, allows a pulp and paper company to reduce production costs and reduce the overall amount of OBA present, while maintaining an acceptable level of brightness in the paper product.

The invention has been described with reference to the representative embodiments. Obvious modifications and alterations will occur to others upon reading and understanding the preceding detailed description. It is intended that the invention be construed as including all such modifications and alterations insofar as they come within the scope of the appended claims or the equivalents thereof.

### EXAMPLES

In these Examples, sufficient base, with the base being sodium hydroxide as an aqueous 50% solution of NaOH was added to achieve appropriate pH for the Penetrant compound being tested. All percentages in these examples are given on a weight percent dry pulp basis.

Treatment.

Handsheets were made of bleached pulp and then used in the experiments, in which the Penetrant compound solutions were applied either on a wet sheet (before or after the press) before drum-drying or after drum-drying at 100° C. The third option was split-feed application. The surface sizing application was followed by one more round on a drum dryer.

The load of the tested Penetrant compound solutions was determined based on the dry weight of the pulp sample. The Penetrant compound solutions were applied using a rod, as uniformly as possible, as solutions in water (unless methanol was used in application of a competitor's product as indicated in the Tables). The test sheets were dried using a laboratory drum drier under uniform conditions (one round) and then, after measuring the brightness, subjected to the accelerated aging tests as described below.

Brightness Reversion Experiments (Thermal Aging).

The 3×9 cm samples cut out of test sheets were kept in a water bath at 70° C. for about 3 days. The samples were equilibrated in a constant humidity room before measuring brightness.

Test Equipment:

Laboratory drum drier

“Elrepho” or another instrument for brightness measurements

Micropipette

Surface size application kit (pad and size 3-application rod)

Constant humidity room

Photoreactor

Water bath/thermostat accommodating a floating plastic box with paper samples 100-mL application cuvette for the soaking method

Dry Surface Application Procedure (Surface Sizing):

1. Prepare 8×8-inch hand sheet according to the standard procedure. The target dry weight is 2.5 g. Pass wet hand sheets through one cycle on the drum dryer.
2. Cut the sheets into 4 smaller squares (approximate wt of 0.625 g each).
3. Tape one side of the smaller square (test sheet) to a glass pad using Scotch tape of length greater than the side of the sheet.
4. The application rod is placed on the scotch tape and a volume of 0.2 ml of the mix is applied on the tape against the rod using a micropipette.
5. Penetrant compound solution is applied in such away that it is evenly distributed on the tape to cover the entire test sheet.
6. Quickly draw the solution from the tape over sheet using the rod so that the Penetrant compound solution is evenly applied on to the entire sheet.
7. Drum-dry the test sheet and equilibrate at room temperature.
8. Measure brightness and yellowness.
   Dry Surface Application Procedure (Surface Sizing, Soaking Method):
1. Prepare 8^{×}8-inch hand sheet according to the standard procedure. The target dry weight is 2.5 g. Pass wet hand sheets through one cycle on the drum dryer.
2. Cut ⅛^{th strip of the sheet (}0.31 g).
3. In a 50 ml test tube, prepare solutions of pre-cooked starch (if needed) and Penetrant compound solutions based on the pre-determined pickup rate and target dose.
4. Dip the paper strip into the solution for 10 seconds, let it drip for 35 seconds and then pass it through the press.
5. Drum-dry the test sheet and equilibrate at room temperature.
6. Measure brightness and yellowness.
   Wet End Application Procedure:
1. An 8^{×}8-inch sheet is made and dewatered using the press with two blotters at the bottom and one blotter on top. The consistency of the pressed sheet is around 40%.
2. The top blotter and the bottom most blotter are removed from the sheet after the press.
3. The sheet along with one bottom blotter are cut into 4 smaller test sheets of equal size (approximate dry weight of the sheet is 0.625 g).
4. The test sheet is taped along with the blotter to the glass pad as described in the “dry surface application procedure.”
5. Solution 1 is applied as described in the dry surface application procedure.
6. After application, the test sheet along with the wet blotter is removed from the glass pad, the tape is removed and the blotter is separated from the test sheet. The blotter is discarded.
7. The test sheet is then drum dried and equilibrated at room temperature.

Split Feed Application Procedure:
1. An 8^{×}8-inch sheet is made according to the standard procedure.
2. The sheet formed on the screen is then padded with 4 blotters.
3. The sheet along with blotters is then couched using a heavy metal roller. This process removes excess water from the sheet to increase the consistency of the sheet to around 20%.
4. Three top blotters are removed from the sheet.
5. The sheet and one blotter are then removed from the screen and cut into 4 smaller pieces as described in the “Wet end Application Procedure”.
6. The sheet and the blotter are then taped to the glass pad as described in the “Wet end Application Procedure”.
7. Solution 2 is applied as described in the “Wet end Application Procedure”.
8. The test sheet is then pressed with 2 blotters on each side.
9. After press, all the blotters are removed and the sheet is drum dried. Solution 2 is then applied to the sheet, dried and measured as described in steps 3 to 8 of “Dry Surface Application Procedure”.
   Testing Results
   I. Mill Trial

The trial data were collected at a Southern kraft mill (compare the data to lab tests for Southern Mill 3—see below). The table below gives sample data. In several tests, application of the product (Composition A) in a size press, with an OBA in the sizing solution, at 5 lb/t and higher doses consistently provided a 1.5-point brightness increase accompanied by improved color of the paper sheet (reflected in decreasing DE values). Returning to the standard mill conditions (no penetrant composition applied) resulted in a decrease of brightness to the background level. This experiment was reproduced three times.

Trial Data: R457 Brightness, E313 Whiteness, DE(ΔE)=Sq.rt.[(L₀−L)²+(a₀−a)²+(b₀−b)²]

| Time, h | Dose, lb/t | Brightness | DE | WI E313 |
|---|---|---|---|---|
| 0 | 0 | 94.5 | 1.99 | 142.24 |
| 0.58 | 0 | 94.5 | 1.61 | 144.95 |
| 1.17 | 0 | 94.5 | 1.83 | 143.34 |
| 1.75 | 0 | 94.5 | 1.93 | 143.52 |
| 2.33 | 0 | 94.5 | 1.52 | 146.66 |
| 2.92 | 4 | 95.25 | 0.71 | 150 |
| 3.5 | 4 | 95.25 | 0.89 | 148.29 |
| 4.08 | 4 | 95.5 | 0.88 | 148.4 |
| 4.67 | 5 | 96 | 0.76 | 149.46 |
| 5.25 | 5 | 96 | 0.72 | 149.84 |
| 5.83 | 6 | 96 | 0.44 | 152.6 |
| 6.42 | 8 | 96 | 0.44 | 156.01 |
| 7 | 8 | 96 | 0.35 | 154.15 |
| 7.58 | 8 | 95.75 | 0.4 | 154.92 |
| 8.17 | 10 | 96 | 0.52 | 152.24 |

(1)
Several compositions were tested and gave good results in laboratory simulation of the PM application. The chemicals were applied as 40% solutions.
II. Paper Made of Kraft Pulp, Chelant-Metabisulfite Compositions

Kraft hardwood pulp was evaluated (thick stock and headbox, surface sizing application in 6% starch, soaking method). The untreated pulp from Kamyr line demonstrated normal response 0.6-0.8 units. The headbox stock was consistently responsive, and the data show that applying 0.1% Composition C or an alternative formulation allow cutting the dose of an optical brightener in half at least. As a rule, less chelant is required in case of kraft pulp as compared to mechanical pulp. Thus, Composition C is more preferred for kraft pulp while Composition B is more preferred for mechanical pulp.

Thick Stock

| # | Treatment | Br | Ye |
|---|---|---|---|
| 1 | Starch | 84.03 | 5.94 |
| 2 | 0.1% Composition C | 84.61 | 5.56 |
| 3 | 0.2% Composition C | 84.67 | 5.50 |
| 4 | 0.3% Composition C | 84.71 | 5.38 |

Headbox

| # | Treatment | Br |
|---|---|---|
| 1 | 0% OBA 2 | 87.56 |
| 2 | 0% OBA 2 + 0.1% Composition C | 88.07 |
| 3 | 20% OBA | 92.08 |
| 4 | 20% OBA + 0.1% Composition C | 92.80 |
| 5 | 40% OBA | 93.05 |
| 6 | 40% OBA + 0.1% Composition C | 93.60 |
| 7 | 100% OBA | 93.43 |
| 8 | 100% OBA + 0.1% Composition C | 93.95 |

II. Synergisms

Activation of an optical brightener: kraft pulp, Composition C (0, 0.2%) with OBA (0, 0.2%)

| OBA1 | Br | vs.(0, 0) |
|---|---|---|
| C0, OBA0 | 78.24 | 0 |
| C0, OBA0.2 | 79.74 | 1.5 |
| C0.2, OBA0 | 80.43 | 2.19 |
| C0.2, OBA0.2 | 82.53 | 4.29 |
| Synergism | | 0.6 |
| OBA2 | Water | vs.(0, 0) |
| C0, OBA0 | 78.24 | 0 |
| C0, OBA0.2 | 80.11 | 1.87 |
| C0.2, OBA0 | 80.43 | 2.19 |
| C0.2, OBA0.2 | 82.91 | 4.67 |
| Synergism | | 0.61 |

Chelant-metabisulfite synergism: mechanical-kraft pulp blends, headbox furnish, wet end application

Western Mill

| | Br |
|---|---|
| 0.2% Composition G | 67 |
| 0.2% Sodium metabisulfite | 67.29 |
| 0.1% Composition G + 0.1% | 67.73 |
| Sodium metabisulfite | |
| Drum-dried | 66.4 |
| Air-dried | 67.76 |

Midwest Mill

| | Br |
|---|---|
| 0.2% Composition G | 63.58 |
| 0.2% Sodium metabisulfite | 63.81 |
| 0.1% Composition G + 0.1% | 65.16 |
| Sodium metabisulfite | |
| Drum-dried | 62.28 |
| Air-dried | 64.87 |

IV. Paper Made of Mechanical Pulp, Chelant-Metabisulfite Compositions (Soaking Method in 2.3% Starch)

TMP1

| # | Treatment | Br | Ye |
|---|---|---|---|
| 1 | 0.05% Composition B | 80.50 | 11.37 |
| 2 | 0.1% Composition B | 80.79 | 11.17 |
| 3 | 0.2% Composition B | 81.44 | 10.82 |
| 4 | 0.05% (Na metabisufite30:DTPA 5:DTMPA 5) | 80.93 | 11.06 |
| 5 | 0.1% (Na metabisufite30:DTPA 5:DTMPA 5) | 81.41 | 10.79 |
| 6 | 0.2% (Na metabisufite30:DTPA 5:DTMPA 5) | 81.87 | 10.50 |
| 7 | Starch only -- Control | 79.40 | 11.77 |

TMP 2

| Treatment | Br | Ye |
|---|---|---|
| Control | 78.43 | 12.06 |
| 0.2% Composition B | 81.11 | 10.70 |
| 0.2% (Sodium metabisulfite 30:DTPA 10) | 81.31 | 10.52 |

V. Paper Made of Bleached Mechanical Pulp, Substitution of Metabisulfite with Alternative Reductive/Nucleophilic Chemistries in Chelant-Metabisulfite Compositions (Surface Sizing Application in 2.5% Starch, Soaking Method)

Alternative reducing components such as FAS and P(III) compounds can be combined with a chelant or with a metabisulfite-based product. BTHP, a commercially acceptable P(III) product performs better in combination with the chelant and sodium nitrite (an activator).

TMP2

| # | Treatment | Br | Ye |
|---|---|---|---|
| 1 | 0.2% Composition B | 78.96 | 12.25 |
| 2 | 0.2% THP | 78.66 | 12.38 |
| 3 | 0.2% FAS | 78.75 | 12.20 |
| 4 | 0.2% TCP | 79.20 | 12.13 |
| 5 | 0.2% FAS | 78.00 | 12.17 |
| 6 | 0.2% THP + 0.01% NaNO2 | 79.22 | 12.00 |
| 7 | 0.2% TCP + 0.01% NaNO2 | 79.11 | 12.12 |
| 8 | Starch only | 77.51 | 12.98 |

TMP2

| # | Treatment | Br | Ye |
|---|---|---|---|
| 1 | Starch only | 78.83 | 11.95 |
| 2 | 0.05% FAS + 0.15% Composition B | 81.35 | 10.72 |
| 3 | 0.2% BTHP | 81.06 | 10.90 |
| 4 | 0.1% BTHP + 0.1% Composition B | 80.28 | 11.32 |
| 5 | 0.2% (3 BTHP:1 DTMPA) | 81.40 | 10.73 |
| 6 | 0.2% Composition B | 81.30 | 10.90 |

RMP

| # | Treatment | Br | Ye |
|---|---|---|---|
| 1 | Starch only | 76.75 | 13.57 |
| 2 | 0.2% BTHP | 78.59 | 12.64 |
| 3 | 0.2% BTHP + 0.01% NaNO2 | 78.75 | 12.54 |
| 4 | 0.2% TCP + 0.01% NaNO2 | 78.38 | 12.70 |

RMP

| # | Treatment | Br | Ye |
|---|---|---|---|
| 1 | Starch only | 77.02 | 13.68 |
| 2 | 0.1% Composition B | 78.80 | 12.87 |
| 3 | 0.2% Composition B | 79.10 | 12.61 |
| 4 | 0.1% (Na metabisufite30:DTPA 5:DTMPA 5) | 78.90 | 12.82 |
| 5 | 0.2% (Na metabisufite30:DTPA 5:DTMPA 5) | 78.99 | 12.74 |
| 6 | 0.066% (Na metabisufite30:Mn Salt with | 78.28 | 13.04 |
| | DTPA 10) | | |
| 7 | 0.1% (Na metabisufite17.8:FAS 12.2:DTMPA | 78.41 | 13.08 |
| | 10) | | |
| 8 | 0.2% (Na metabisufite17.8:FAS 12.2:DTMPA | 78.76 | 12.89 |
| | 10) | | |
| 9 | 0.1% FAS | 78.51 | 12.91 |
| 10 | 0.2% FAS | 79.04 | 12.59 |

VI. Paper Made of Bleached Kraft Pulp, Combining Chelants in a Chelant-Metabisulfite or Chelant-Alternative Chemistry Formulation (Surface Sizing Application in 2.5% Starch, Soaking Method)

Hardwood kraft 2

| # | Treatment | Br | Ye |
|---|---|---|---|
| 1 | Starch only | 87.48 | 4.21 |
| 2 | 0.2% Composition B | 88.38 | 3.65 |
| 3 | 0.2% (Na metabisufite30:DTPA 5:DTMPA 5) | 88.40 | 3.35 |

Mechanical and kraft pulp, chelant-metabisulfite and chelant-metabisulfite-DTC compositions The data clearly illustrate brightness recovery upon application of the penetrant compound (compare brightness of air-dried, drum-dried and treated drum-dried sheets) RMP, couch (wet end) application in water

| # | % Composition A | % DTC | Br | Ye |
|---|---|---|---|---|
| 1 | 0.257% | 0.0025% | 79.53 | 11.65 |
| 2 | 0.257% | 0.00125% | 79.73 | 11.93 |
| 3 | 0.184% | 0.0025% | 80.05 | 11.63 |
| 4 | 0.184% | 0.00125% | 79.98 | 11.51 |
| Air dried | | | 80.15 | 11.30 |
| Drum dried | | | 78.28 | 12.60 |

CTMP, Surface Sizing Application

| # | % Composition A | Br | Ye |
|---|---|---|---|
| 1 | 0.513% | 69.73 | 18.41 |
| Drum dried | | 68.47 | 19.02 |
| Air dried | | 70.72 | 17.35 |

Kraft, Surface Sizing Application

| # | % Composition A | Br | Ye |
|---|---|---|---|
| 1 | 0.513% | 88.41 | 3.51 |
| Drum dried | | 87.50 | 4.01 |
| Air dried | | 88.16 | 3.56 |

Examples of Long-Term Thermal Protection

RMP, Surface Sizing Application

| | % | % | | | | | % |
|---|---|---|---|---|---|---|---|
| # | Composition A | DTC | Br | Ye | TABr | TAYe | Inh. |
| 1a | 0.513% | 0.0025% | 79.14 | 12.36 | 77.62 | 12.81 | 23 |
| 1b | 0.513% | 0.0025% | 79.35 | 12.16 | 77.91 | 12.56 | 27 |
| 2a | 0.513% | 0.0050% | 78.78 | 12.65 | 77.79 | 12.7 | 50 |
| 2b | 0.513% | 0.0050% | 78.76 | 12.56 | 77.4 | 12.92 | 31 |
| Drum | | | 77.9 | 12.92 | 75.93 | 13.82 | |
| dried | | | | | | | |

Kraft, Surface Sizing Application

| | % | % | | | | | % |
|---|---|---|---|---|---|---|---|
| # | Composition A | DTC | Br | Ye | TABr | TAYe | Inh. |
| 1a | 0.513% | 0.0025% | 87.89 | 4.01 | 86.25 | 4.36 | 24 |
| 1b | 0.513% | 0.0025% | 87.74 | 3.98 | 86.24 | 4.46 | 31 |
| 2a | 0.513% | 0.0050% | 87.17 | 4.52 | 86.27 | 4.54 | 58 |
| 2b | 0.513% | 0.0050% | 86.46 | 4.91 | 86.3 | 4.53 | 93 |
| Drum | | | 87.64 | 3.92 | 85.47 | 5.05 | |
| dried | | | | | | | |
| Drum | | | 87.75 | 3.99 | 85.61 | 4.95 | |
| dried | | | | | | | |

While the present invention is described above in connection with representative or illustrative embodiments, these embodiments are not intended to be exhaustive or limiting of the invention. Rather, the invention is intended to cover all alternatives, modifications and equivalents included within its spirit and scope, as defined by the appended claims.

What is claimed is:

1. A composition that preserves and enhances the brightness of a ligno-cellulosic material comprising an effective amount of a penetrant compound comprising (i) a reductive nucleophilic agent and (ii) a chelant in a paper or tissue machine.

2. The composition of claim 1, wherein the ligno-cellulosic material is pulp, paper, recycled paper or paper tissue.

3. The composition of claim 1, wherein the reductive nucleophilic agent is selected from the group consisting of water-soluble inorganic sulfites, bisulfites, metabisulfites, substituted phosphines and tertiary salts thereof, formamidinesulfinic acid and salts thereof, and formaldehyde bisulfite adduct.

4. The composition of claim 3, wherein the bisulfite is sodium bisulfite.

5. The composition of claim 1, wherein the chelant is at least one of an organic phosphonate, phosphate or a carboxylate and salts thereof.

6. The composition of claim 5, wherein the phosphonate is diethylene-triamine-pentamethylene phosphonic acid (DTMPA) and salts thereof.

7. The composition of claim 1, further comprising dithiocarbamates and derivatives thereof.

8. A composition that preserves and enhances the brightness of a ligno-cellulosic material comprising an effective amount of a penetrant compound comprising phosphonate and bisulfite and salts thereof in a paper or tissue machine.

9. A composition of claim 1, wherein the penetrant compound comprises sodium DTMPA and sodium bisulfite.

10. The composition of claim 1, wherein the penetrant compound further comprises polyacrylate.

11. A method that preserves and enhances the brightness of a ligno-cellulosic material comprising applying penetrant compound of claim 1 directly to the wet sheet before the dryers, to the dry sheet in a size press or split-fed.

12. A method to prevent thermal brightness loss in a paper machine comprising applying the penetrant compound of claim 1 directly to the wet sheet before the dryers, to the dry sheet in a size press or split-fed.

13. A method to prevent thermal brightness loss during storage in wet mechanical, chemical, chemi-mechanical or mixtures thereof pulp comprising applying the penetrant compound of claim 1, directly to the wet sheet before the dryers, to the dry sheet in a size press or split-fed.

14. An enhanced optical brightener composition comprising whitening agents and a penetrant composition of claim 1.

15. Pulp, paper, recycled paper or paper tissue produced from ligno-cellulosic material by application of a penetrant compound of claim 1.

16. A ligno-cellulosic material with enhanced brightness and brightness-stabilized by application of a penetrant compound of claim 1.

17. A composition according to claim 1, which additionally contains at least one carrier or additive typically used in papermaking.
